(19) United States
(12) Patent Application Publication
(10) Pub. No.: US 2009/0300599 A1
(43) Pub. Date: Dec. 3, 2009

(54) Systems and methods of utilizing virtual machines to protect computer systems

(76) Inventor: Matthew Thomas Piotrowski, Mountain View, CA (US)

Correspondence Address: KOLISCH HARTWELL, P.C., 200 PACIFIC BUILDING, 520 SW YAMHILL STREET, PORTLAND, OR, 97204, US

(21) Appl. No.: 12/156,378

(22) Filed: May 30, 2008

(51) Int. Cl. G06F 21/00; G06F 9/445

(52) U.S. Cl. 717/174; 726/2; 718/1

(57) ABSTRACT

Systems and methods are provided for utilizing virtual machines to protect computer systems. A first virtual machine may be initiated to execute a computer program. When the computer program attempts to access a computer file, a determination may be made of whether the first virtual machine is allowed access to the computer file. If access is allowed, the virtual machine may be permitted access to the computer file, and the computer program may thereafter access the computer file. A first (or “master”) virtual machine may additionally or alternatively cause initiation of a second (or “slave”) virtual machine to access untrusted computer files. Master virtual machines may be configured to communicate with and/or control slave virtual machines.

### BACKGROUND OF THE DISCLOSURE

A virtual machine is a software implementation of a machine (or computer) that executes computer programs like a real machine. There are two general types of virtual machines: a system virtual machine and a process virtual machine.

A system virtual machine allows the multiplexing of the underlying physical machine between different virtual machines, each running its own operating system. The software layer providing the virtualization is called a virtual machine monitor or hypervisor.

A process virtual machine runs as a normal application inside an operating system and supports a single process. It is created when that process is started and destroyed when it exits. Its purpose is to provide a platform-independent programming environment that abstracts away details of the underlying hardware or operating system, and allows a program to execute in the same way on any platform. One of the most well-known examples of a process virtual machine is the Java Virtual Machine (“JVM”).

Other examples of virtual machines are disclosed in U.S. Pat. Nos. 6,223,202; 6,374,286; 6,789,156; 6,851,112; 6,931,544; 7,036,006; 7,039,911; 7,146,602; 7,191,441; 7,203,808; 7,277,998; 7,277,999; 7,281,102; 7,325,233; 7,334,136; 7,337,445; 7,356,817; and U.S. Patent Application Publication Nos. 2002/0099753; 2006/0184935; and 2007/0283347. The complete disclosures of the above patents and patent applications are herein incorporated by reference for all purposes.

### SUMMARY OF THE DISCLOSURE

Systems and methods are provided for protecting computer systems by using virtual machines. In one example, a method of utilizing virtual machines to protect a computer system is provided, the method comprising the steps of: receiving a request to execute a computer program; initiating a first virtual machine having a first identity and being configured to execute the computer program; instructing the first virtual machine to execute the computer program; receiving from the first virtual machine a request to access a first computer file on behalf of the computer program; determining whether the first virtual machine is allowed access to the first computer file; and permitting the first virtual machine access to the first computer file if the first virtual machine is allowed access to the first computer file.

In another example, a method of utilizing virtual machines to protect a computer system is provided, the method comprising the steps of: receiving a request to execute a computer program; initiating a first virtual machine having a first identity and being configured to execute the computer program; instructing the first virtual machine to execute the computer program; receiving from the first virtual machine a request to initiate a second virtual machine to access an untrusted first computer file; and initiating a second virtual machine having a second identity different than the first identity, the second virtual machine being configured to access the untrusted first computer file.

In another example, a virtual machine having a first identity associated with a computer program is provided wherein the virtual machine is configured to: execute the computer program; receive a request from the computer program to access a first computer file; request permission to access the first computer file; receive permission to access the first computer file; and access the first computer file.

In another example, a master virtual machine having a first identity is provided, wherein the master virtual machine is configured to: execute a computer program; receive a request from the computer program to access an untrusted first computer file; cause initiation of a slave virtual machine configured to access the untrusted first computer file, the slave virtual machine having a second identity different from the first identity; communicate with the slave virtual machine.

In other examples, storage mediums readable by a processor of a computer system are provided, wherein each storage medium has embodied thereon a computer program of commands executable by the processor, the program being adapted to be executed to perform the steps described above.

### BRIEF DESCRIPTION OF THE DRAWINGS

FIG. 1 depicts an example computer system incorporating disclosed systems and methods.

FIG. 2 depicts an example method of installing a computer program on a computer system, such as the one depicted in FIG. 1, so that the computer program is executable within a virtual machine.

FIG. 3 depicts an example method of initiating a virtual machine for execution of a computer program and access of a computer file by the virtual machine.

FIG. 4 depicts the example computer system of FIG. 1 where a control program has initiated three virtual machines to execute three computer programs.

FIG. 5 depicts an example method of presenting an interface for approving access to a computer file.

FIG. 6 depicts an example interface for approving access to a computer file

FIG. 7 depicts an example method of initiating a second or slave virtual machine to access an untrusted file.

FIG. 8 depicts the example computer system of FIGS. 1 and 3 where one of the virtual machines has caused the initiation of a second or slave virtual machine to open an untrusted file.

### DETAILED DESCRIPTION OF THE DISCLOSURE

Systems and methods are provided for utilizing virtual machines to protect computer systems. In particular, a virtual machine manager (hereafter referred to as a “control program”) may initiate a virtual machine when a request to execute a computer program is received. The initiated virtual machine may be customized for the particular computer program of which execution is requested.

The control program may instruct the created virtual machine to execute the computer program. When the computer program attempts to access a particular computer file, the virtual machine may make a request to the control program to access the computer file. The control program may determine whether the virtual machine is permitted access to the computer file, and permit or deny access accordingly.

For the purposes of this disclosure, to “access a computer file” means to open, edit, copy, effect change upon, or otherwise interact with the computer file, even metadata (e.g., filename, data modified, file location) associated with the computer file, or even a duplicate of the computer file. When a virtual machine is said to be “configured to access a computer file,” this means the virtual machine is executing a computer program that is able to access the computer file and/or the virtual machine is allowed access to the computer file.

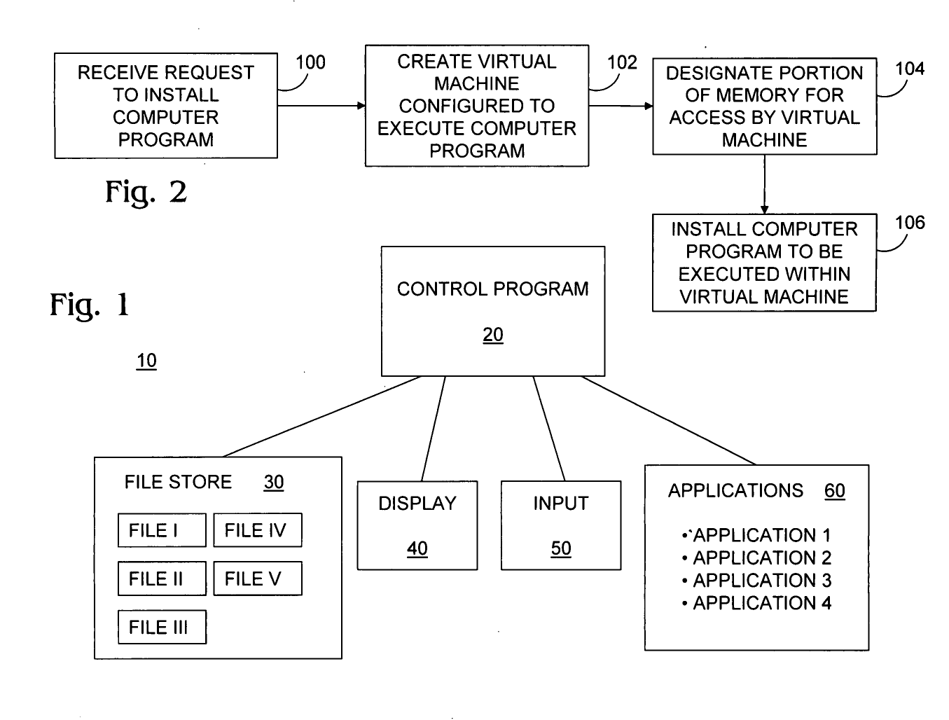

Referring now to FIG. 1, a computer system 10 is shown having various components. Computer system 10 may be one or more computers working together to provide a computing environment that allows the execution of computer programs. Computer system 10 may include a control program 20, a file store 30, a display 40, one or more input devices 50, and one or more applications 60.

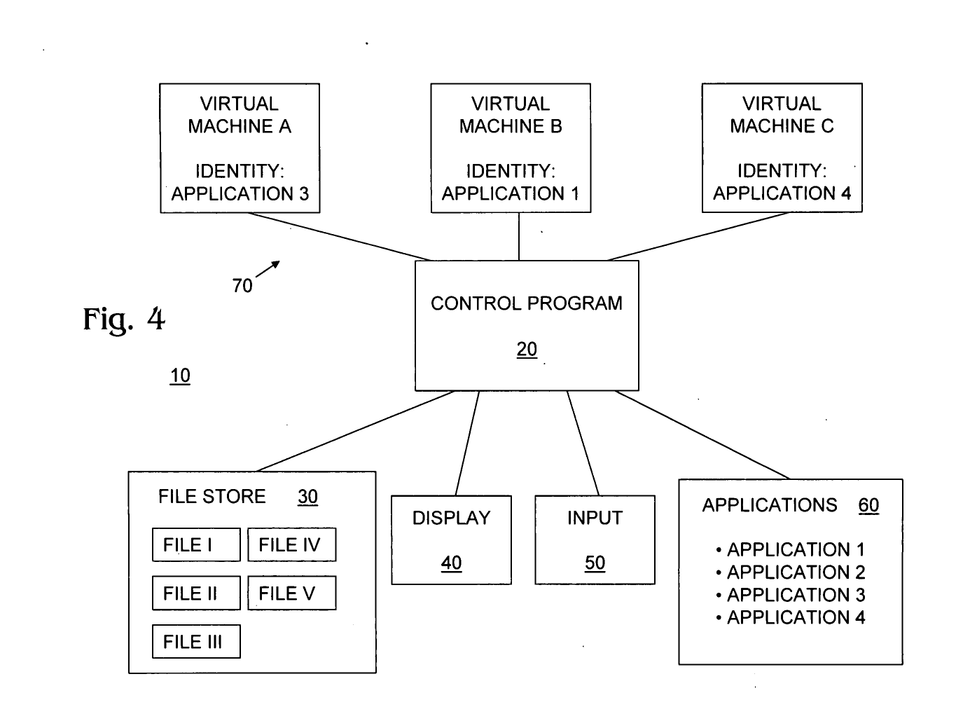

Control program 20 may be a computer program that executes to control one or more virtual machines (see reference numeral 70 in FIG. 4), including the initiation, termination and computer file access abilities of the one or more virtual machines. Often referred to in the art as a virtual machine manager, virtual machine monitor or a hypervisor, control program 20 may be an integral part of an operating system of computer system 10, or it may be a software layer running on top of or below the operating system.

File store 30 may comprise memory of the computer system 10, such as RAM, ROM, hard disc space, or flash memory, as well as memory on other computers or computer systems in network communication with computer system 10. File store 30 may contain one or more computer files, including personal files owned by one or more users.

Display 40 may comprise a display component, such as a computer monitor or printer. Input 50 may also comprise input components, such as keyboards and mice. Applications 60 may comprise one or more computer programs that may be available for execution by users of computer system 10. Computer programs may be any piece of software, any application, or any other set of instructions which may be executed by one or more processors (not shown) of computer system 10.

When a user of computer system 10 desires to execute a computer program contained in applications 60, control program 20 may be configured to ensure that the computer program is executed within a virtual machine. In some embodiments, when a computer program is installed on computer system 10, the operating system of computer system 10 may not be used to install the computer program, as would be typical in most computing environments. Instead, control program 20 may create a custom virtual machine exclusively for the execution of that computer program, and install the computer program so that it may be executed in the created virtual machine. The created virtual machine that is not yet running on the system may sometimes be referred to as a “virtual machine image.”

An example method of such a computer program installation is depicted in FIG. 2. In step 100, a request may be made to control program 20 to install the computer program. This request may come from the operating system of computer system 10, or it may come directly from a user desiring to install a computer program on computer system 10.

When control program 20 receives such a request, in step 102 it may create a virtual machine configured specifically to execute the computer program to be installed. One example of how a virtual machine may be configured specifically to execute a particular computer program is to identify the virtual machine by the computer program.

Another example of how a virtual machine may be configured specifically to execute a particular computer program is shown at step 104. There may be runtime or other computer files, such as logs to which the computer program requires access. Accordingly, in step 104, control program 20 may designate a portion of memory in file store 30 as being accessible to the created virtual machine, or to serve as a virtual hard disk for the created virtual machine. For example, a virtual machine created to execute Excel may be permitted access to portions of a hard drive or other memory in file store 30 containing computer files necessary for the execution of Excel (e.g., c:\Program Files\Microsoft Office\). Such designation may be accomplished using various methods, such as by adding the virtual machine's identity to an access control list associated with a directory.

In step 106, the computer program may be installed so that it may be executed, sometimes exclusively, by the created virtual machine. Additionally, the steps discussed above may be performed in different sequences and in different combinations, not all steps being required for all embodiments of the method.

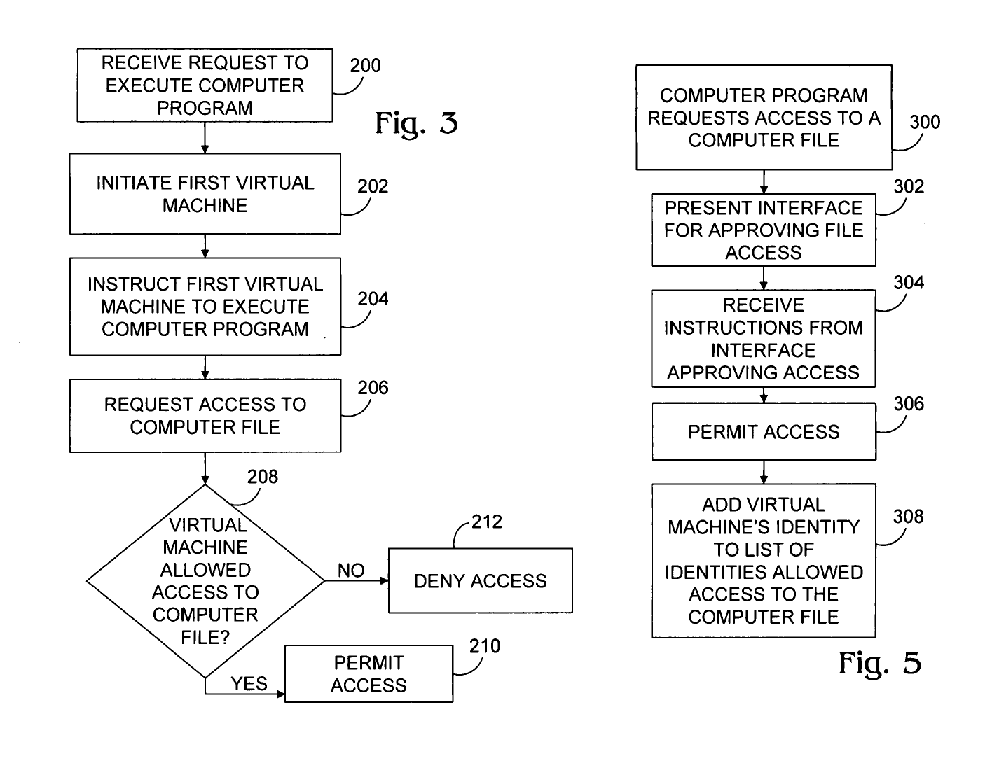

FIG. 3 depicts an example method where computer programs are executed by custom virtual machines. Upon computer system 10 being requested to execute a computer program, in step 200, control program 20 may receive a request to execute the computer program. In step 202, control program 20 may initiate a virtual machine configured to execute the computer program. In step 204, control program 20 may instruct the initiated virtual machine to execute the computer program.

FIG. 4 depicts an example scenario where three computer programs, APPLICATION 3, APPLICATION 1 and APPLICATION 4, are being executed in a plurality 70 of virtual machines on computer system 10. APPLICATION 3 is executing in VIRTUAL MACHINE A, which is identified therefore as “APPLICATION 3”; APPLICATION 1 is executing in VIRTUAL MACHINE B, which is identified therefore as “APPLICATION 1”; and APPLICATION 4 is executing in VIRTUAL MACHINE C, which is identified therefore as “APPLICATION 4.”

At some point, the computer program executing within a virtual machine may request access to a computer file contained in file store 30. Referring back to FIG. 3, this request may be generated and communicated by the virtual machine to control program 20 on behalf of the computer program. In step 206, control program 20 may receive the request. In step 208, control program 20 may determine whether the virtual machine is allowed access to the requested computer file. In order to make this determination, each virtual machine may be assigned an identity.

An identity may be usable to determine whether a virtual machine is allowed access to computer files. In some embodiments, a virtual machine's identity may be associated with the computer program that the virtual machine is configured to execute. For example, if a user requests execution of MICROSOFT Excel, the virtual machine initiated for the execution of Excel may be identified as “Excel.”

Determining whether a virtual machine is allowed access to a computer file may be accomplished in several ways. In some embodiments, control program 20 may authenticate a virtual machine's identity against a list of identities permitted to access the computer file. For example, access to a computer file may be governed by an access control list granting one or more entities access to the computer file Some access control lists additionally may indicate the type of access that is permitted (e.g., read-only, read/write), although this is not required. When a computer program executing in a virtual machine attempts to access a computer file, the access control list associated with that file may be consulted to determine whether the identity of the virtual machine is permitted the type of access that the computer program is requesting.

In other embodiments, when the virtual machine requests access to a computer file, it may also send a token to control program 20. Control program 20 may then determine whether the token indicates that the virtual machine is to be permitted access to the first computer file, and act accordingly.

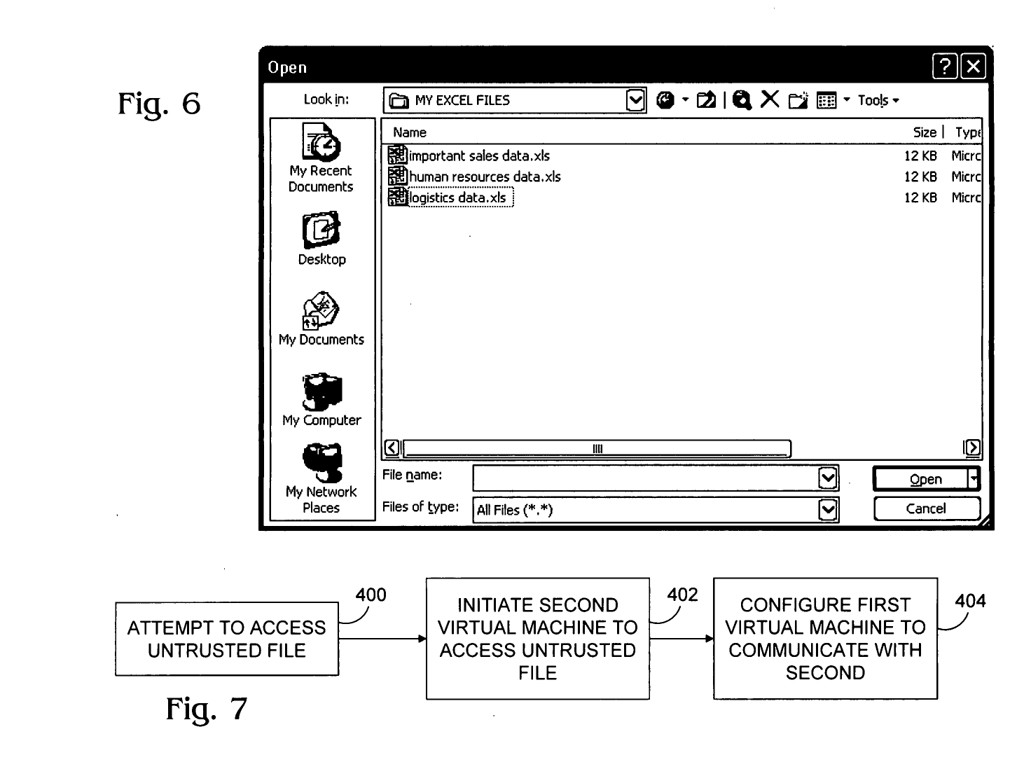

In some embodiments, control program 20 may cause an interface for approving access to a computer file to be presented. An example method of presenting an interface for approving access to a computer file is shown in FIG. 5. In step 300 (which is similar to step 206 of FIG. 3), control program 20 is requested to access a computer file. In step 302, control program 20 may present an interface for approving access to a computer file. This interface may be a graphical user interface or other interface, and in some embodiments may resemble a file selection window similar to the one shown in FIG. 6. Additionally, the interface may be part of control program 20 or may be separate from control program 20.

In step 304, control program 20 may receive instructions from the presented interface as to whether access to a computer file is approved. For example, if the user selects a file from an interface like the one shown in FIG. 6, the interface may notify control program 20 of the user's file choice. If access is approved, in step 306, access to the computer file is permitted. Additionally, the steps discussed above may be performed in different sequences and in different combinations, not all steps being required for all embodiments of the method.

When access to a computer file is approved via an interface, such as the one shown in FIG. 6, control program 20 may need to make an adjustment somewhere on computer system 20 to ensure that the virtual machine may access the computer file again in the future. For embodiments where each computer file is associated with a list of identities permitted to access the computer file (e.g., an access control list), in step 308, the identity of the virtual machine may be added to the list of identities so that the virtual machine can access the computer file again in the future.

In some embodiments where additional security is desired or where users are temporary, it may be desirable to periodically remove added virtual machine identities added when the file access approval interface is deployed. Accordingly, virtual machine identities added to lists of identities associated with computer files may be stored in volatile memory such as RAM. In such cases, when computer system 10 is rebooted (i.e., powered down and restarted so that information in RAM is cleared), any added virtual machine identities will be deleted.

If access to a computer file by a virtual machine is determined to be allowed, access to the computer file may be permitted in step 210. However, if control program 20 determines in step 208 that the virtual machine is not allowed access to the computer file, in step 212 control program 20 may deny the virtual machine access to the computer file altogether. Additionally, the steps discussed above may be performed in different sequences and in different combinations, not all steps being required for all embodiments of the method.

In another aspect, a high level of security and application isolation may be desired for a computer system. Accordingly, a first virtual machine may be configured to initiate or cause initiation of a second virtual machine to access untrusted files. Untrusted computer files may be computer files obtained from the Internet or other outside sources which possibly could contain malicious data. Common examples of untrusted files are attachments to emails and files downloaded from the Internet.

In some embodiments, the second virtual machine may access the untrusted computer file as it is stored in file store 30. In other embodiments, the second virtual machine may access the untrusted computer file by receiving data from the first virtual machine comprising a copy of the untrusted computer file. Such data may be communicated between virtual machines using messages or other similar means. In yet other embodiments, the first virtual machine may notify the second virtual machine of a location on a network or the Internet of the untrusted computer file, and the second virtual machine may access the untrusted computer file by downloading a copy.

An example method of using a second virtual machine to access an untrusted file is depicted in FIG. 7. In step 400, a computer program executing in a first virtual machine requests access to an untrusted file. In step 402, the first virtual machine may cause initiation of a second virtual machine, which may be configured to execute a computer program designed to access computer files of the same type as the untrusted file, to access the untrusted file.

In some embodiments, causing initiation of a second virtual machine means the first virtual machine sends a request to control program 20 to initiate the second virtual machine, and control program 20 initiates (i.e., causes execution on the second virtual machine. In other embodiments, the first virtual machine may be capable of initiating the second virtual machine without the help of control program 20, such as by forking off the second virtual machine as a child process.

Virtual machines that cause the initiation of other virtual machines may be referred to as “master” virtual machines. Likewise, the virtual machines initiated by “master” virtual machines may be referred to as “slave” virtual machines. The terms “master’ and “slave” are meant only to be relative in nature. Master and slave virtual machines may be identical. Furthermore, slave virtual machines may recursively initiate further slave machines.

A slave virtual machine may have a different identity than the master virtual machine that initiated it. Accordingly, a master virtual machine's identity may in some instances be usable to access a particular computer file, while a slave virtual machine created by the master virtual machine may not have access to the same computer file.

Referring back to FIG. 7, some control programs 20 may in step 404 configure master virtual machines to communicate with and even control (to various degrees) slave virtual machines. In other embodiments where master virtual machines initiate slave virtual machines directly, master virtual machines may be configured to communicate with and even control (to various degrees) slave virtual machines. Additionally, the steps discussed above may be performed in different sequences and in different combinations, not all steps being required for all embodiments of the method.

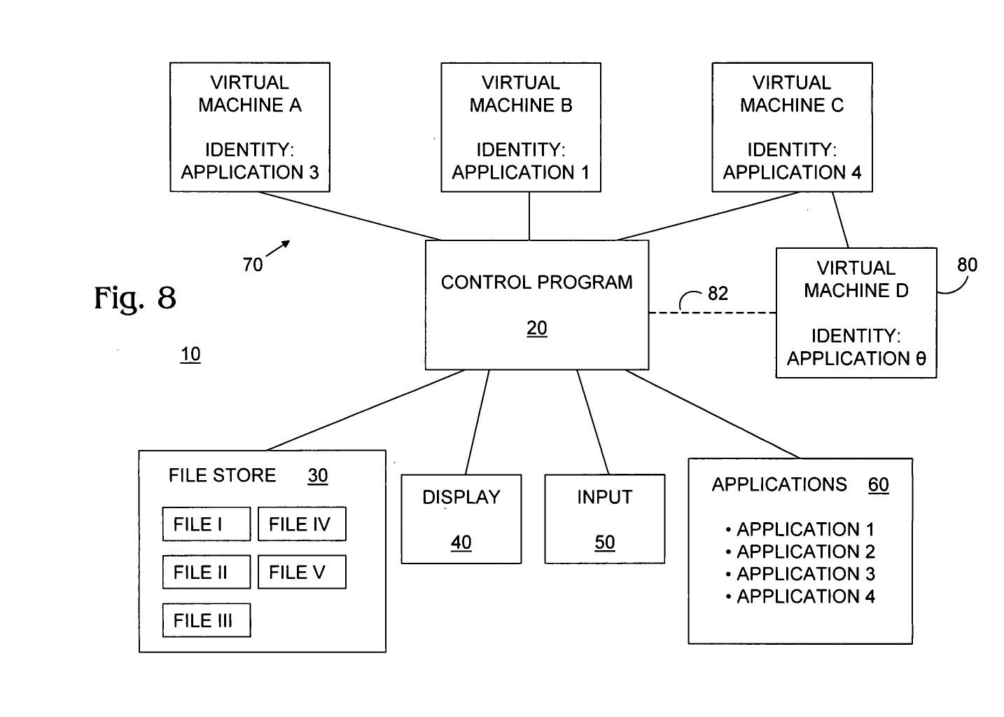

An example of where master and slave virtual machines are in use is depicted in FIG. 8. VIRTUAL MACHINE C is identified by the application it is running, APPLICATION 4. VIRTUAL MACHINE C has requested the initiation of a slave virtual machine VIRTUAL MACHINE D (referenced by numeral 80). VIRTUAL MACHINE D is identified by the application that it is executing, APPLICATION Θ.

In one common scenario, APPLICATION 4 may be an email application, and APPLICATION Θ may be a program that generates previews of email contents. When APPLICATION 4 receives an email, VIRTUAL MACHINE C may initiate VIRTUAL MACHINE D. It may then communicate the email to VIRTUAL MACHINE D so that APPLICATION Θ can generate a preview. If the email contains corrupt or malicious data, any damage that may be caused will be limited to VIRTUAL MACHINE D and the computer files to which VIRTUAL MACHINE D has access.

While the present description has been provided with reference to the foregoing embodiments, those skilled in the art will understand that many variations may be made therein without departing from the spirit and scope defined in the following claims. The description should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element or the equivalent thereof, such claims should be understood to include incorporation of one or more such elements, neither requiring, nor excluding, two or more such elements.

What is claimed is:

1. A method of utilizing virtual machines to protect a computer system, the method comprising the steps of:
receiving a request to execute a computer program;
initiating a first virtual machine having a first identity and being configured to execute the computer program;
instructing the first virtual machine to execute the computer program;
receiving from the first virtual machine a request to access a first computer file on behalf of the computer program;
determining whether the first virtual machine is allowed access to the first computer file; and
permitting the first virtual machine access to the first computer file if the first virtual machine is allowed access to the first computer file.

2. The method of claim 1, wherein the step of determining whether the first virtual machine is allowed access to the first computer file includes authenticating the first identity against a list of identities permitted to access the first computer file.

3. The method of claim 2, further comprising the steps of:
prior to permitting the first virtual machine access to the first computer file, presenting an interface for approving access to the first computer file;
receiving instructions from the interface approving access to the first computer file; and
adding the first identity to the list of identities permitted to access the first computer file.

4. The method of claim 3, wherein adding the first identity includes storing the first identity in volatile memory so that when the computer system is rebooted, the added first identity is deleted.

5. The method of claim 1, further comprising the steps of:
prior to permitting the first virtual machine access to the first computer file, presenting an interface for approving access to the first computer file; and
receiving instructions from the interface approving access to the first computer file.

6. The method of claim 5, wherein the interface for approving access to the first computer file resembles a file selection graphical user interface.

7. The method of claim 1, wherein the step of receiving the request to access the first computer file further includes receiving from the first virtual machine a token, and the step of determining whether the first virtual machine is allowed access to the first computer file further includes determining whether the token indicates that the first virtual machine is to be permitted access to the first computer file.

8. The method of claim 1, further comprising the steps of:
receiving from the first virtual machine a request to initiate a second virtual machine to access an untrusted second computer file; and
initiating the second virtual machine having a second identity different than the first identity, the second virtual machine being configured to access the untrusted second computer file.

9. The method of claim 8, further comprising the step of configuring the first virtual machine to communicate with the second virtual machine.

10. The method of claim 8, wherein the first virtual machine's first identity is usable to obtain access by the first virtual machine to the first computer file, and the second virtual machine's second identity is not usable to obtain access to the first computer file.

11. The method of claim 1, further comprising the steps of, prior to receiving the request to execute the computer program:
receiving a request to install the computer program;
creating the first virtual machine configured to execute the computer program;
designating a portion of memory to be accessible to the first virtual machine; and
installing the computer program so that it only can be executed by the first virtual machine.

12. A method of utilizing virtual machines to protect a computer system, the method comprising the steps of:
receiving a request to execute a computer program;
initiating a first virtual machine having a first identity and being configured to execute the computer program;
instructing the first virtual machine to execute the computer program;
receiving from the first virtual machine a request to initiate a second virtual machine to access an untrusted first computer file; and
initiating a second virtual machine having a second identity different than the first identity, the second virtual machine being configured to access the untrusted first computer file.

13. The method of claim 12, further comprising the step of configuring the first virtual machine to communicate with the second virtual machine.

14. The method of claim 12, further comprising the steps of:
receiving from the first virtual machine a request to access a second computer file on behalf of the computer program;
determining whether the first virtual machine is allowed access to the second computer file; and
permitting the first virtual machine access to the second computer file if the first virtual machine is allowed access to the second computer file.

15. A virtual machine for use on a computer system, the virtual machine having a first identity associated with a computer program and being configured to:
execute the computer program;
receive a request from the computer program to access a first computer file;
request permission to access the first computer file;
receive permission to access the first computer file; and
access the first computer file.

16. The virtual machine of claim 15, wherein requesting permission to access the first computer file includes presenting an interface for approving access to the first computer file.

17. The virtual machine of claim 15, wherein the machine is further configured to:
receive a request from the computer program to access an untrusted second computer file;
cause initiation of a second virtual machine configured to access the untrusted second computer file, the second virtual machine having a second identity different from the first identity, and
communicate with the second virtual machine.

18. A master virtual machine for use on a computer system, the master virtual machine having a first identity and being configured to:
execute a computer program;
receive a request from the computer program to access an untrusted first computer file;
cause initiation of a slave virtual machine configured to access the untrusted first computer file, the slave virtual machine having a second identity different from the first identity;
communicate with the slave virtual machine.

19. The master virtual machine of claim 18, wherein the master virtual machine is further configured to:
receive a request from the computer program to access a second computer file;
request permission to access the second computer file;
receive permission to access the second computer file; and
access the second computer file.

20. The master virtual machine of claim 19, wherein the master virtual machine's first identity is usable to obtain access to the second computer file, and the slave virtual machine's second identity is not usable to obtain access to the second computer file.

21. A storage medium, readable by a processor of a computer system, having embodied therein a first computer program of commands executable by the processor, the program being adapted to be executed to:
receive a request to execute a second computer program;
initiate a first virtual machine having a first identity and being configured to execute the second computer program;
instruct the first virtual machine to execute the second computer program;
receive from the first virtual machine a request to access a first computer file on behalf of the second computer program;
determine whether the first virtual machine is allowed access to the first computer file; and
permit the first virtual machine access to the first computer file if the first virtual machine is allowed access to the first computer file.

22. The storage medium of claim 21, wherein the first computer program is further adapted to be executed to authenticate the first identity against a list of identities permitted to access the first computer file.

23. The storage medium of claim 22, wherein the first computer program is further adapted to be executed to:
present an interface for approving access to the first computer file prior to permitting the first virtual machine access to the first computer file;
receive instructions from the interface approving access to the first computer file; and
add the first identity to the list of identities permitted to access the first computer file.

24. The storage medium of claim 23, wherein the first computer program is further adapted to be executed to store the first identity in volatile memory so that when the computer system is rebooted, the added first identity is deleted.

25. The storage medium of claim 21, wherein the first computer program is further adapted to be executed to:
present an interface for approving access to the first computer file prior to permitting the first virtual machine access to the first computer file, and
receive instructions from the interface approving access to the first computer file.

26. The storage medium of claim 25, wherein the interface for approving access to the first computer file resembles a file selection graphical user interface.

27. The storage medium of claim 21, wherein the first computer program is further adapted to be executed to:
receive from the first virtual machine a token; and
determine whether the token indicates that the first virtual machine is to be permitted access to the first computer file.

28. The storage medium of claim 21, wherein the first computer program is further adapted to be executed to:
receive from the first virtual machine a request to initiate a second virtual machine to access an untrusted second computer file; and
initiate the second virtual machine having a second identity different than the first identity, the second virtual machine being configured to access the untrusted second computer file.

29. The storage medium of claim 28, wherein the first computer program is further adapted to be executed to configure the first virtual machine to communicate with the second virtual machine.

30. The storage medium of claim 28, wherein the first virtual machine's first identity is usable to obtain access by the first virtual machine to the first computer file, and the second virtual machine's second identity is not usable to obtain access to the first computer file.

31. The storage medium of claim 21, wherein the first computer program is further adapted to be executed to, prior to receiving the request to execute the second computer program:
receive a request to install the second computer program;
create the first virtual machine configured to execute the second computer program;
designate a portion of memory to be accessible to the first virtual machine; and
install the second computer program so that it only can be executed by the first virtual machine.

32. A storage medium, readable by a processor of a computer system, having embodied therein a first computer program of commands executable by the processor, the first computer program being adapted to be executed to:
receive a request to execute a second computer program;
initiate a first virtual machine having a first identity and being configured to execute the second computer program;
instruct the first virtual machine to execute the second computer program;
receive from the first virtual machine a request to initiate a second virtual machine to access an untrusted first computer file; and
initiate a second virtual machine having a second identity different than the first identity, the second virtual machine being configured to access the untrusted first computer file.

33. The storage medium of claim 32, wherein the first computer program is further adapted to be executed to configure the first virtual machine to communicate with the second virtual machine.

34. The storage medium of claim 32, wherein the first computer program is further adapted to be executed to:
receive from the first virtual machine a request to access a second computer file on behalf of the second computer program;
determine whether the first virtual machine is allowed access to the second computer file; and
permit the first virtual machine access to the second computer file if the first virtual machine is allowed access to the second computer file.

35. A storage medium, readable by a processor of a computer system, having embodied therein a first computer program of commands executable by the processor to implement a first virtual machine having a first identity, the first computer program being adapted to be executed to:
execute the second computer program;
receive a request from the second computer program to access a first computer file;
request permission to access the first computer file;
receive permission to access the first computer file; and
access the first computer file.

36. The storage medium of claim 35, wherein the first computer program is further adapted to be executed to present an interface for approving access to the first computer file.

37. The storage medium of claim 35, wherein the first computer program is further adapted to be executed to:
receive a request from the second computer program to access an untrusted second computer file;
cause initiation of a second virtual machine configured to access the untrusted second computer file, the second virtual machine having a second identity different from the first identity, and
communicate with the second virtual machine.

38. A storage medium, readable by a processor of a computer system, having embodied therein a first computer program of commands executable by the processor to implement a master virtual machine having a first identity, the first computer program being adapted to be executed to:
execute a second computer program;
receive a request from the second computer program to access an untrusted first computer file;
cause initiation of a slave virtual machine configured to access the untrusted first computer file, the slave virtual machine having a second identity different from the first identity;
communicate with the slave virtual machine.

39. The storage medium of claim 38, wherein the first computer program is further adapted to be executed to:
receive a request from the second computer program to access a second computer file;
request permission to access the second computer file;
receive permission to access the second computer file; and
access the second computer file.

40. The storage medium of claim 39, wherein the master virtual machine's first identity is usable to obtain access to the second computer file, and the slave virtual machine's second identity is not usable to obtain access to the second computer file.
